(19) United States
(12) Patent Application Publication
(10) Pub. No.: US 2024/0329185 A1
(43) Pub. Date: Oct. 3, 2024

(54) SIGNAL SOURCE POSITION ESTIMATION APPARATUS, SYSTEM, AND METHOD

(71) Applicant: NEC Corporation, Minato-ku, Tokyo (JP)

(72) Inventors: Wataru KOHNO, Tokyo (JP); Reishi KONDO, Tokyo (JP); Sakiko MISHIMA, Tokyo (JP)

(73) Assignee: NEC Corporation, Minato-ku, Tokyo (JP)

(21) Appl. No.: 18/698,517

(22) PCT Filed: Oct. 28, 2021
(86) PCT No.: PCT/JP2021/039791

§ 371 Date: Apr. 4, 2024

(51) Int. Cl. G01S 5/22

(52) U.S. Cl. CPC G01S 5/22

(57) ABSTRACT

An object of the present disclosure is to provide a signal source position estimation apparatus, a system, a method, and a non-transitory computer-readable medium that are capable of accurately estimating positions of a plurality of different signal sources even when signals are generated from the plurality of signal sources at substantially the same time. The signal source position estimation apparatus according to the present disclosure includes: a time difference of arrival (TDOA) candidate value evaluation means for calculating, for all combinations of two sensors selected from among a plurality of sensors, all candidate values of a time difference of arrival being a difference in time of arrival (TOA) of signals generated from each of a plurality of signal sources between the two sensors; and a solution candidate distribution derivation means for deriving a solution candidate distribution formed by distributing whether predetermined coordinates are coordinates of the plurality of signal sources.

### TECHNICAL FIELD

The present disclosure relates to a signal source position estimation apparatus, a system, a method, and a non-transitory computer-readable medium, and more particularly, to a signal source position estimation apparatus, a system, a method, and a non-transitory computer-readable medium that are capable of accurately estimating a position of each of a plurality of different signal sources even when signals are generated from the plurality of signal sources at substantially the same time.

### BACKGROUND ART

A method for estimating a position of a signal source of a signal, based on the signal acquired by a plurality of sensors is known. Such a method is a method for calculating a direction and a position of the signal source, based on a time difference between signals detected by two sensors and coordinates of the sensors. One example of such a method is a method for calculating a time difference of signals detected by a cross-power spectrum phase analysis (CSP) method and estimating a direction of a signal source. Examples of the signal source include a sound source, a radio wave source, and the like. Examples of the sensor include an electronic microphone, a radar, and the like. Non Patent Literature 1 discloses a method in which a hyperbola is drawn from a time difference detected by two sensors, and an intersection of a plurality of hyperbolas by a plurality of combinations of two sensors is estimated as a position of a signal source. Note that a plurality of sensors may be referred to as a sensor array.

Paragraph [0014] of Patent Literature 2 describes that “in band images G7 and G13 of FIGS. 4 (b) and 4 (c), it can be seen that sound sources having different frequencies exist at different portions A and B of region D, as indicated by arrows in each of the figures. Therefore, when a band image Gp is generated from a sound source estimation image G and displayed as in the present example, the difference for each frequency becomes easy to see, and thereby the sound source can be reliably estimated even when a plurality of sound sources having different frequencies exist in a close place.” That is, Patent Literature 2 discloses estimating a sound source for a plurality of sound sources having different frequencies. Patent Literature 2 does not disclose estimation of positions of a plurality of sound sources having the same frequencies.

Paragraph of Patent Literature 3 describes that “a relative delay time between microphone pairs is determined from input microphone position information and a sound source search target direction, and the relative delay time is transmitted to an estimation direction information generation unit together with the sound source search target direction as a set.” In addition, paragraph [0052] of Patent Literature 3 describes that, “when a function has a plurality of peaks, it is assumed that there are a plurality of sound sources each having a peak as an arrival direction. Therefore, not only a direction of each sound source may be estimated at the same time, but also the number of sound sources may be estimated.” Patent Literature 3 does not disclose that all candidate values of TDOA, which is described later, between two sensors are calculated for all combinations of two sensors, hyperbolic information is calculated based on coordinates of the sensor and the candidate values of TDOA, and a solution candidate distribution is derived based on the hyperbolic information.

### CITATION LIST

### Patent Literature

Patent Literature 1: Japanese Unexamined Patent Application Publication No. 2014-021315
Patent Literature 2: Japanese Unexamined Patent Application Publication No. 2015-159458
Patent Literature 3: International Patent Publication No. WO2018/003158

### Non Patent Literature

Non Patent Literature 1: Takuro Okumoto, Masahiro Fukumoto: “Estimation of Sound Source Position by Cross Correlation Method”, Bachelor's Degree Paper, Kochi Institute of Technology, pages 3 to 11, 2012

### SUMMARY OF INVENTION

### Technical Problem

When signals are generated from a plurality of different signal sources at substantially the same time, it is difficult to separate the signals, and it is difficult to accurately calculate a time difference of arrival (TDOA), which is a difference in time of arrival of the generated signals, between different sensors. As a result, there is a problem that, when signals are generated from a plurality of different signal sources at substantially the same time, it is difficult to accurately estimate positions of the plurality of signal sources.

An object of the present disclosure is to provide a signal source position estimation apparatus, a system, a method, and a non-transitory computer-readable medium that solve the problems described above.

### Solution to Problem

A signal source position estimation apparatus according to the present disclosure includes:
a time difference of arrival (TDOA) candidate value evaluation means for calculating, for all combinations of two sensors selected from among a plurality of sensors, all candidate values of a time difference of arrival being a difference in time of arrival (TOA) of signals generated from each of a plurality of signal sources between the two sensors;
a solution candidate distribution derivation means for calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
a distribution peak extraction means for extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

A usage management system according to the present disclosure includes a plurality of sensors and a signal source position estimation apparatus, wherein
each of the plurality of sensors includes
   a detection means for detecting a signal generated from each of a plurality of signal sources, and
   a notification means for notifying the signal source position estimation apparatus of a plurality of times of arrival (TOAs) indicating times when the generated signal arrives at the plurality of sensors,
the signal source position estimation apparatus includes
   a time difference of arrival (TDOA) candidate value evaluation means for calculating, for all combinations of two sensors selected from among the plurality of sensors, all candidate values of a time difference of arrival being a difference in time of arrival of signals generated from each of the plurality of signal sources between the two sensors,
   a solution candidate distribution derivation means for calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information, and
   a distribution peak extraction means for extracting a plurality of peak coordinates having a distribution value higher than surrounding distribution values from the solution candidate distribution, and estimating the plurality of peak coordinates as a generation position of the plurality of signal sources, and
the time of arrival is a time when a signal generated from each of the plurality of signal sources arrives at each of the plurality of sensors.

A method according to the present disclosure includes:
calculating, for all combinations of two sensors selected from among a plurality of sensors, all candidate values of a time difference of arrival (TDOA) being a difference in time of arrival (TOA) of signals generated from each of a plurality of signal sources between the two sensors;
calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

A non-transitory computer-readable medium according to the present disclosure stores a program that causes a computer to execute:
calculating, for all combinations of two sensors selected from among a plurality of sensors, all candidate values of a time difference of arrival (TDOA) being a difference in time of arrival (TOA) of signals generated from each of a plurality of signal sources between the two sensors;
calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

### Advantageous Effects of Invention

According to the present disclosure, it is possible to provide a signal source position estimation apparatus, a system, a method, and a non-transitory computer-readable medium that are capable of accurately estimating positions of a plurality of different signal sources even when signals are generated from the plurality of signal sources at substantially the same time.

### BRIEF DESCRIPTION OF DRAWINGS

FIG. 1 is a schematic diagram illustrating a state where a signal generated from one signal source is detected by a plurality of sensors;

FIG. 2 is a graph illustrating signal waveforms of signals received by sensors;

FIG. 3 is a graph illustrating hyperbolas generated based on TDOA and coordinates of sensors;

FIG. 4 is a distribution diagram illustrating a solution candidate distribution of a signal source;

FIG. 5 is a schematic diagram illustrating a state where signals generated from two signal sources are detected by a plurality of sensors;

FIG. 6 is a graph illustrating signal waveforms of signals received by sensors;

FIG. 7 is a block diagram illustrating a system according to the example embodiment;

FIG. 8 is a graph illustrating signal waveforms of signals received by sensors according to the example embodiment and a distribution diagram illustrating a solution candidate distribution of a signal source;

FIG. 9 is a flowchart illustrating an operation of a signal source position estimation apparatus according to the example embodiment;

FIG. 10 is a graph illustrating a signal waveform of a signal received by the sensor according to the example embodiment;

FIG. 11 is a graph illustrating signal waveforms of signals received by the sensors according to the example embodiment;

FIG. 12 is a graph illustrating hyperbolic information according to the example embodiment and a distribution diagram illustrating a solution candidate distribution of a signal source;

FIG. 13 is a distribution diagram illustrating a solution candidate distribution of a signal source according to the example embodiment; and

FIG. 14 is a distribution diagram illustrating a solution candidate distribution of a signal source according to the example embodiment.

### EXAMPLE EMBODIMENT

Hereinafter, example embodiments of the present invention are described with reference to the drawings. In the drawings, the same or corresponding element is denoted by the same reference sign, and redundant descriptions are omitted as necessary for clarity of description.

### <General Position Estimation Method>

Before describing the example embodiment of the present disclosure, a general position estimation method is described.

First, a case where there is one signal source is described.

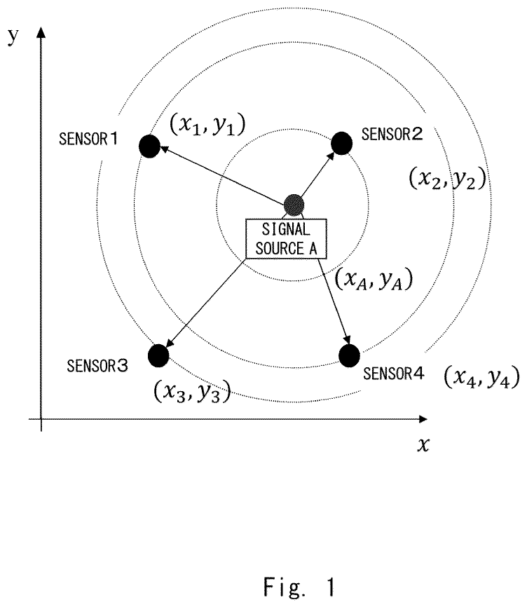

FIG. 1 is a schematic diagram illustrating a state where a signal generated from one signal source is detected by a plurality of sensors.

FIG. 1 illustrates a case where four sensors detect a signal generated from a signal source.

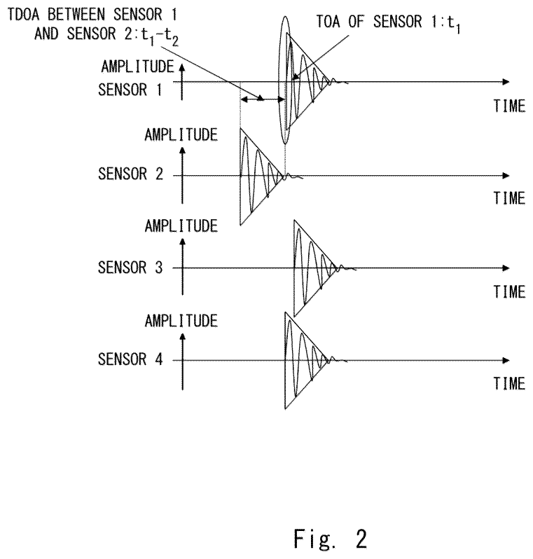

FIG. 2 is a graph illustrating signal waveforms of signals received by sensors.

In FIG. 2, the horizontal axis represents time, and the vertical axis represents the amplitude of the signal.

As illustrated in FIG. 1, sensors 1 to 4 for detecting a signal generated from a signal source A are provided around the signal source A. Herein, the position (coordinates) of the signal source A is (x_{A}, y_{A}). Further, the coordinates of the sensor 1 are (x₁, y₁), the coordinates of the sensor 2 are (x₂, y₂), the coordinates of the sensor 3 are (x₃, y₃), and the coordinates of the sensor 4 are (x₄, y₄). The sensors 1 to 4 may be collectively referred to as sensors.

As illustrated in FIG. 2, when a signal is generated from the signal source A, each of the sensors 1 to 4 detect a signal. In the present example, since the sensor 2 is located at the closest position to the signal source A, the sensor 2 detects the signal first. Since the sensors 1 and 4 are located at second closest positions to the signal A, the sensors 1 and 4 detect the signal second. Since the sensor 3 is located at a third closest position to (farthest position from) the signal A, the sensor 3 detects the signal third.

At this time, the sensor stores a time of arrival (TOA) of a signal generated from the signal source A at the sensor. For example, the TOA of the sensor 1 is t₁. Then, a time difference of arrival (TDOA) between the sensors is determined. For example, the TDOA between the sensor 1 and the sensor 2 is t₁−t₂.

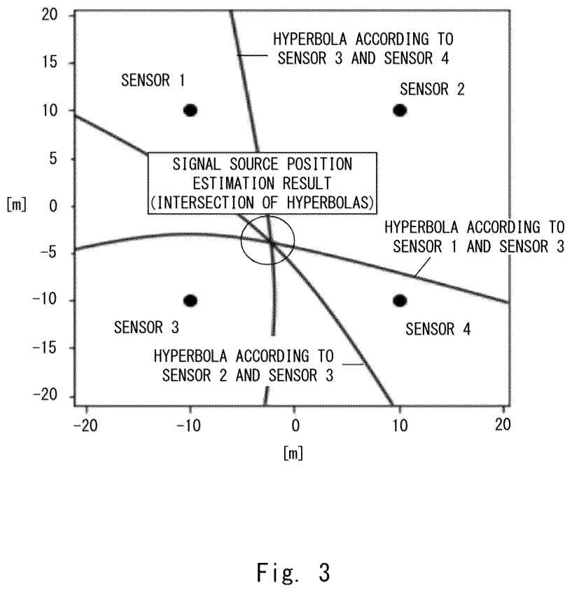

FIG. 3 is a graph illustrating hyperbolas generated based on TDOA and coordinates of the sensors.

In FIG. 3, the horizontal axis represents the distance in the x-direction, and the vertical axis represents the distance in the y-direction.

A hyperbola with solution candidates as illustrated in FIG. 3 may be drawn according to the TDOA (tᵢ−tⱼ) between the sensors i and j and the coordinates of the sensors. Herein, i and j are each an integer of 1 to 4, and indicate the number of the sensor. Specifically, the hyperbola (two-dimensional) of the sensors i and j is a graph satisfying equation (1).

$$\sqrt{{( {x}_{i} - x )}^{2} + {( {y}_{i} - y )}^{2}} - \sqrt{( {x}_{j} - {x}^{2} ) + {( {y}_{j} - y )}^{2}} - c ( {t}_{i} - {t}_{j} ) ≡ {f}_{ij} ( x , y ) = 0 \qquad ( 1 )$$

Herein, c is the speed of the signal.

In FIG. 3, three hyperbolas are drawn, and the intersection of the hyperbolas are the point (position) being estimated as the position of generation of the signal. In such a way, in two dimensions, it is possible to estimate the signal source by using at least three sensors.

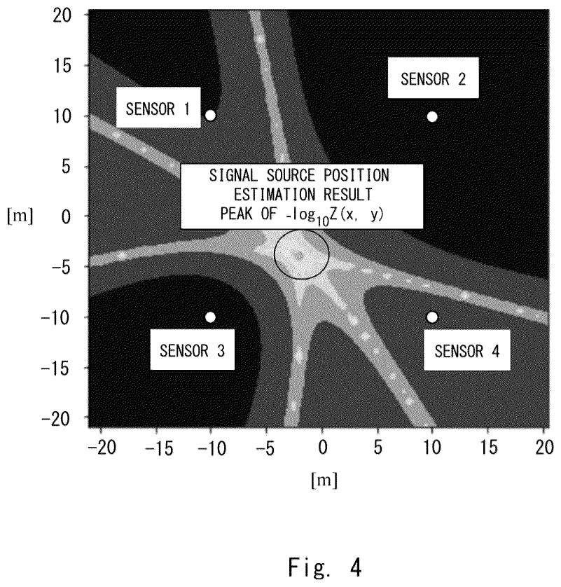

FIG. 4 is a distribution diagram illustrating a solution candidate distribution of a signal source.

In FIG. 4, the horizontal axis represents the distance in the x-direction, and the vertical axis represents the distance in the y-direction.

By transforming the hyperbola represented by equation (1) into a function Z(x, y) represented by equation (2), the hyperbola may be represented as a distribution diagram of the signal source.

$$Z ( x , y ) ≡ A {\prod }_{i = 1}^{N} {\prod }_{j = i}^{N} \frac{1}{\vert {f}_{ij} ( x , y ) \vert + {0}_{+}} \qquad ( 2 )$$

Herein, N represents the number of sensors. A is a normalization constant represented by equation (3).

$$A = {[ {{\int }_{- ∞}}^{∞} {{\int }_{- ∞}}^{∞} Z ( x , y ) dxdy ]}^{- 1} \qquad ( 3 )$$

The function Z(x, y) takes advantage of the divergence of the product of the inverse number of |fᵢⱼ(x, y)|. In the case of Z(x, y), if the coordinates of the signal source is (x₀, y₀), then a peak appears at Z(x₀, y₀). Therefore, it is possible to estimate that the coordinates at which the peak appears is the coordinates of the signal source.

Next, a case where there are two signal sources is described.

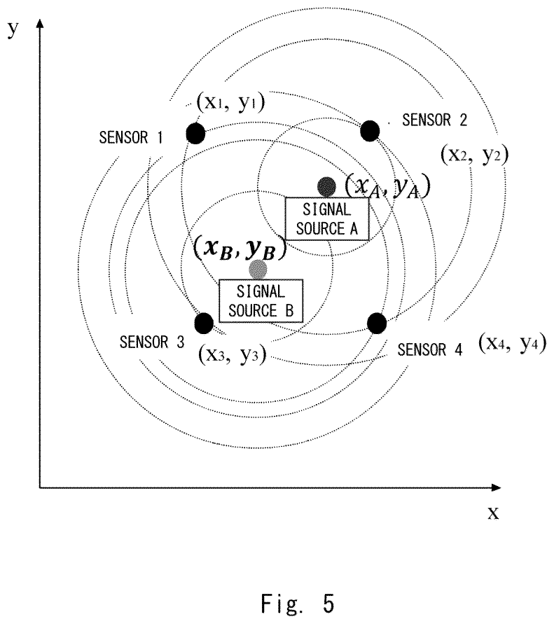

FIG. 5 is a schematic diagram illustrating a state where signals generated from two signal sources are detected by a plurality of sensors.

FIG. 5 illustrates a case where four sensors detect a signal generated from a signal source.

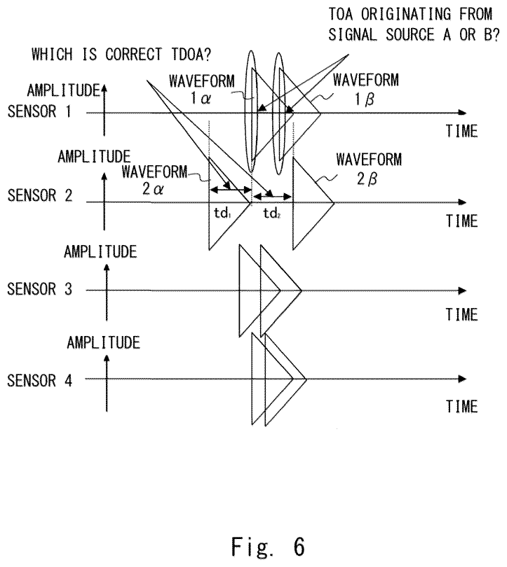

FIG. 6 is a graph illustrating signal waveforms of signals received by the sensors.

In FIG. 6, the horizontal axis represents time, and the vertical axis represents the amplitude of the signal.

As illustrated in FIG. 5, sensors 1 to 4 for detecting signals generated from signal sources A and B are provided around the signal sources A and B. Herein, it is assumed that the position (coordinates) of the signal source A is (x_{A}, y_{A}) and the coordinates of the signal source B is (x_{B}, y_{B}). The coordinates of the sensors 1 to 4 are the same as the coordinates illustrated in FIG. 1.

As illustrated in FIG. 6, when a signal is generated from each of the signal sources A and B, each of the sensors 1 to 4 detects a signal. Specifically, the sensor 1 detects waveforms 1α and 1β. The sensor 2 detects waveforms 2α and 2β. The same applies to the sensors 3 and 4.

Herein, since the coordinates of the signal sources A and B are unknown, it is unclear whether the TOA of the waveform 1α is the TOA derived from either the signal source A or the signal source B. Similarly, it is unclear whether the TOA of the waveform 1β is the TOA derived from either the signal source A or the signal source B. The same applies to the waveforms 2α and 2β of the second sensor.

As a result, the following four patterns are calculated as candidate values for the TDOA (time difference of arrival).
Time difference of arrival t_{d1} between the TOA of the waveform 1α and the TOA of the waveform 2α.
Time difference of arrival t_{d2} between the TOA of the waveform 1α and the TOA of the waveform 2β.
Time difference of arrival between the TOA of the waveform 1β and the TOA of the waveform 2α (not illustrated).
Time difference of arrival between the TOA of the waveform 1β and the TOA of the waveform 2β (not illustrated).

It is unclear which of the above-described four time differences of arrival may be used as the TDOA to be used for estimating the coordinates of the signal source A to correctly estimate the coordinates of the signal source A. Similarly, it is unclear which of the above-described four time differences of arrival may be used as the TDOA to be used in estimating the coordinates of the signal source B to correctly estimate the coordinates of the signal source B.

Problems regarding the signal source position estimation in the case where there are two signal sources are described below.

When there are two or more signals generated at different positions at substantially the same time, the TOA evaluation accuracy is deteriorated, and thereby the accuracy of the signal source position estimation is deteriorated.

Herein, waveforms detected by the first sensor (including the waveforms 1α and 1β) are converted into a spectral waveform in the frequency space by a short-time Fourier transform, and when the characteristic of the obtained spectral waveform is different in each signal source, the signal may be separated in the frequency space. Thus, the direction (localization) of the signal source may be estimated (see Patent Literature 1).

However, when the characteristics of the spectral waveforms in the frequency space are so similar that they cannot be separated, for example, when the signal sources are of the same type and the spectral waveforms are similar, it is difficult to separate the signals, and it becomes difficult to evaluate the TOA derived from each signal source. As a result, it is difficult to evaluate an accurate pattern of TDOA between different sensors, and it is difficult to accurately estimate the positions of the plurality of signal sources.

### Example Embodiments

As described above, it is difficult to accurately estimate the coordinates (positions) of each of a plurality of signal sources generated at substantially the same time and similar to each other.

Example embodiments for solving the above-described problems are described below.

### <Configurations of System and Signal Source Position Estimation Apparatus>

The configuration of a system according to the example embodiment is described.

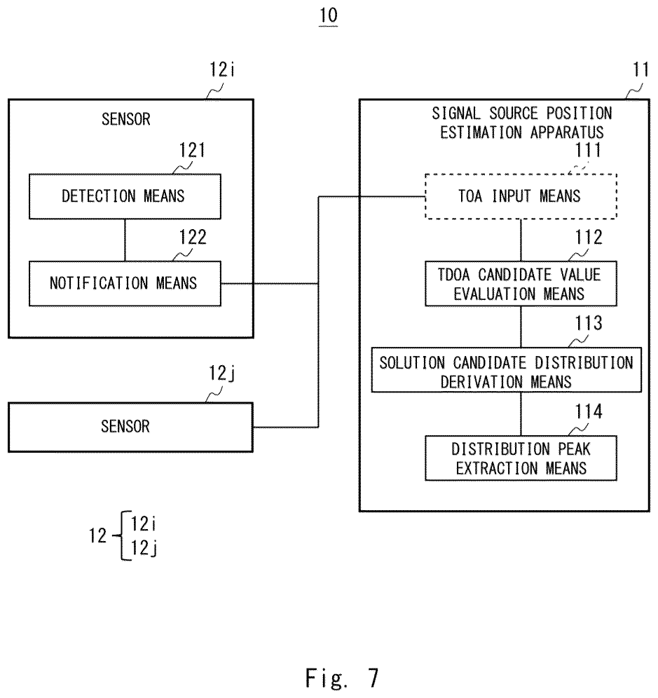

FIG. 7 is a block diagram illustrating a system according to the example embodiment.

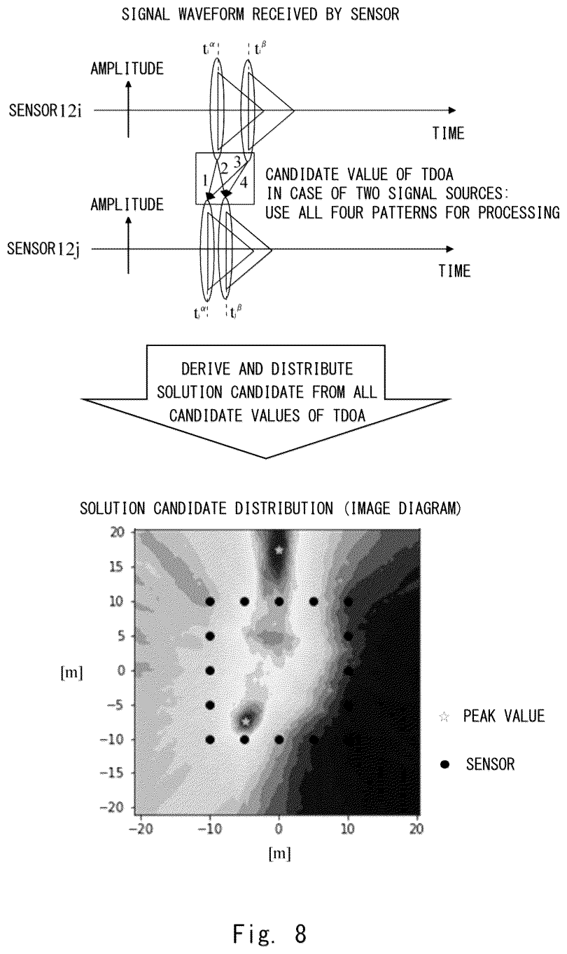

FIG. 8 is a graph illustrating signal waveforms of signals received by sensors according to the example embodiment and a distribution diagram illustrating a solution candidate distribution of a signal source.

As illustrated in FIG. 7, a system 10 according to the example embodiment includes a plurality of sensors 12 and a signal source position estimation apparatus 11. One of the plurality of sensors 12 is referred to as a sensor 12i, and another one is referred to as a sensor 12j. The plurality of sensors 12 each include a detection means 121 and a notification means 122.

The detection means 121 of each of the plurality of sensors 12 detects a signal generated from each of the plurality of signal sources. For example, the sensors 12i and 12j detect a signal waveform as illustrated in FIG. 8.

The notification means 122 of each of the plurality of sensors 12 notifies the signal source position estimation apparatus 11 of a plurality of times of arrival (TOAs) indicating times when signals generated from the plurality of signal sources arrive at the sensor 12. That is, the notification means 122 of the sensor 12i notifies the signal source position estimation apparatus 11 of the plurality of TOAs associated with the plurality of signal sources, indicating the time when the signals generated from each of the plurality of signal sources arrive at the sensor 12i. As illustrated in FIG. 8, the plurality of TOAs of the sensor 12i are tᵢ^{α} and tᵢ^{β}. Similarly, the notification means 122 of the sensor 12j notifies the signal source position estimation apparatus 11 of the plurality of TOAs associated with the plurality of signal sources, indicating the time when the signals generated from each of the plurality of signal sources arrive at the sensor 12j. As illustrated in FIG. 8, the plurality of TOAs of the sensor 12j are tⱼ^{α} and tⱼ^{β}.

The signal source position estimation apparatus 11 includes a TDOA candidate value evaluation means 112, a solution candidate distribution derivation means 113, and a distribution peak extraction means 114.

The TDOA candidate value evaluation means 112 calculates all the candidate values of the time difference of arrival (TDOA), which is the difference in times of arrival (TOAs) between two sensors selected from among the plurality of sensors 12, for all combinations of two sensors. Herein, the TOA is a time when a signal generated from a plurality of signal sources arrives at each of the plurality of sensors 12. In the example illustrated in FIG. 8, TOAs are tᵢ^{α}, tᵢ^{β}, tⱼ^{α}, and tⱼ^{β}.

In a case where there are two signal sources, all of the TDOAs (candidate value information) have four patterns. In the example illustrated in FIG. 8, candidate values of all TDOAs are four patterns illustrated below.
(tᵢ^{α}−tⱼ^{α})
(tᵢ^{α}−tⱼ^{β})
(tᵢ^{β}−tⱼ^{α})
(tᵢ^{β}−tⱼ^{β})

The solution candidate distribution derivation means 113 calculates a plurality of pieces of hyperbolic information, based on the coordinates of each of the plurality of sensors 12 and the candidate values of the TDOA. The solution candidate distribution derivation means 113 derives a solution candidate distribution formed by distributing whether predetermined coordinates are coordinates of a plurality of signal sources, based on the calculated plurality of pieces of hyperbolic information. The solution candidate distribution derivation means 113 derives and distributes solution candidates from candidate value information relating to all the TDOAs. As a result, the solution candidate distribution derivation means 113 derives a solution candidate distribution as illustrated in FIG. 8.

In the solution candidate distribution, an area where solution candidates concentrate appears as a peak value of the distribution. Therefore, the distribution peak extraction means 114 extracts a plurality of peak coordinates having a distribution value higher than the surrounding distribution values from the solution candidate distribution, and estimates the extracted plurality of peak coordinates as the generation positions of the plurality of signal sources.

Note that, in the example embodiment, in a case where coordinates of a plurality of signal sources on a two-dimensional plane are estimated by using the plurality of sensors 12 arranged on the two-dimensional plane, it is desirable that the plurality of sensors 12 be four or more independent sensors in order to acquire the coordinates of the signal source with high accuracy.

Further, in a case where coordinates of a plurality of signal sources in a three-dimensional space are estimated by using the plurality of sensors 12 arranged in the three-dimensional space, it is desirable that the plurality of sensors 12 be five or more independent sensors.

Further, in the example embodiment, as the number of the sensors 12 increases, the accuracy of acquiring the peak coordinates, that is, the position of the signal source, improves. Therefore, it is desirable to increase the number of sensors 12.

In the example embodiment, all of the candidate values of TDOA between two sensors are extracted (enumerated) for all combinations of the two sensors, and the candidate values of all the extracted TDOAs are used for deriving the solution candidate distribution. Herein, a candidate value of TDOA may be selected under a predetermined criterion, and a solution candidate distribution may be derived from the selected candidate value. Then, the peak position of the derived solution candidate distribution may be extracted by the number of signal sources and estimated as the position of the signal source.

As a method for sorting under a predetermined criterion, for example, the solution candidate distribution derivation means 113 may prevent the candidate value of the TDOA being a predetermined time or longer, among the candidate values of the TDOA calculated for all the combinations of the sensors 12, from being used when calculating a plurality of pieces of hyperbolic data.

The signal source position estimation apparatus 11 may further include a TOA input means 111 for acquiring a plurality of TOAs indicating times when signals generated from a plurality of signal sources arrive at each of the plurality of sensors 12. In such a case, the TOA input means 111 acquires a plurality of TOAs from each of the plurality of sensors 12, and the TDOA candidate value evaluation means 112 acquires the plurality of TOAs via the TOA input means 111. In the example illustrated in FIG. 8, the TOA input means 111 acquires tᵢ^{α}, tᵢ^{β}, tⱼ^{α}, and tⱼ^{β} as a plurality of TOAs.

In the following description, the signal source position estimation apparatus 11 is mainly described as having the TOA input means 111.

### <Operation of Signal Source Position Estimation Apparatus>

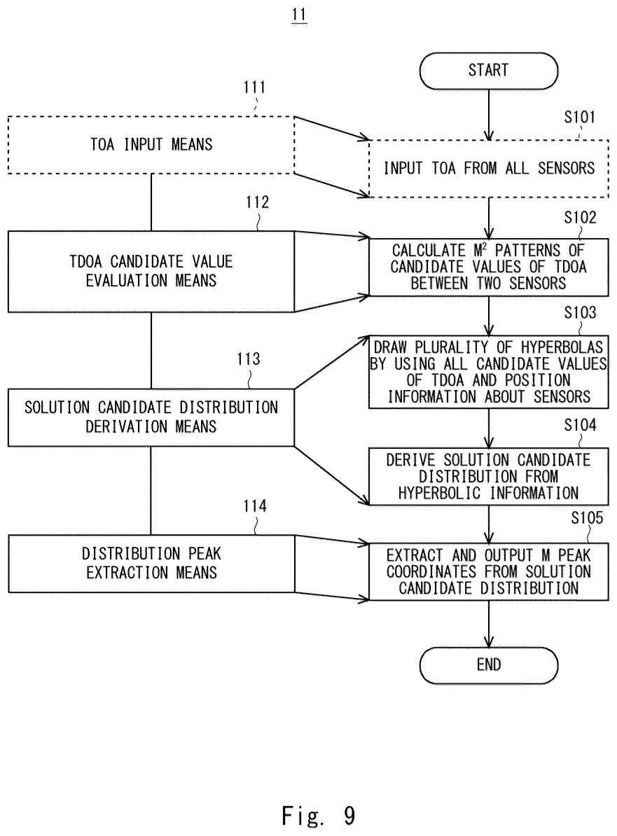

FIG. 9 is a flowchart illustrating an operation of a signal source position estimation apparatus according to the example embodiment.

As illustrated in FIG. 9, the TOA input means 111 of the signal source position estimation apparatus 11 inputs the TOA from all the sensors 12 (step S101). That is, the TOA input means 111 acquires the TOA of all the signal sources acquired by the respective sensors 12 from all the sensors 12.

The TDOA candidate value evaluation means 112 calculates candidate values of TDOA between two sensors for M² patterns (step S102). Here, M is the number of signal sources. Between two sensors means between any two sensors selected from among the plurality of sensors 12, and all combinations thereof. For example, when there are sensors 1 to 4, there are six combinations of between sensors 1 and 2, between sensors 1 and 3, between sensors 1 and 4, between sensors 2 and 3, between sensors 2 and 4, and between sensors 3 and 4.

M² patterns are described.

Since M is the number of signal sources, each of the two sensors senses M waveforms. Herein, since all possible patterns are considered as candidate values of the TDOA, the number of candidate values of the TDOA is M×M=M² patterns. Thus, for example, when the number of signal sources is two, the number of candidates for the TDOA between the two sensors is 2×2=4. After step S102, the solution candidate distribution derivation means 113 draws a plurality of hyperbolas by using all the candidate values of TDOA calculated by the TDOA candidate value evaluation means 112 and the position information (coordinates) of the sensor (step S103). The information about the hyperbola is referred to as hyperbola information.

The solution candidate distribution derivation means 113 derives a solution candidate distribution, based on the hyperbolic information (step S104).

The distribution peak extraction means 114 extracts and outputs M peak coordinates from the solution candidate distribution (step S105).

Details of each component of the signal source position estimation apparatus are described.

### <TOA Input Means>

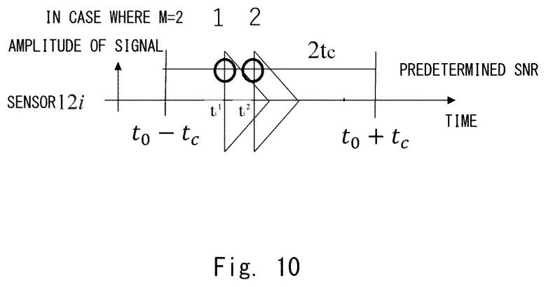

FIG. 10 is a graph illustrating a signal waveform of a signal received by the sensor according to the example embodiment.

FIG. 10 illustrates a signal waveform detected by the sensor 12i when the number M of signal sources is 2. The sensor 12i is any one of the plurality of sensors 12.

As illustrated in FIG. 10, the sensor 12i detects signals generated from each of two signal sources, and notifies the TOA input means 111 of the TOA (time of arrival) of the signals. The TOA input means 111 acquires the TOA of the signal from all the sensors 12. Herein, the TOA acquired by the TOA input means 111 is set to a time to. In FIG. 10, to are tᵢ¹ and tᵢ².

The TOA input means 111 may provide a TOA evaluation period in the vicinity of the acquired time to. The TOA evaluation period is a period from time (t₀−t_{c}) to time (t₀+t_{c}). The period length is 2t_{c}.

Specifically, the TOA input means 111 sets about t_{c}=10√2/340≈0.04 seconds, for example, when it is desired to detect the generation of sound in a space of 10 m (meters) square. However, the speed of sound is assumed to be 340 m/s for simplicity.

By providing the TOA evaluation period, a signal outside the TOA evaluation period is excluded from the evaluation target, and therefore the position of the signal source may be estimated more accurately.

The time of arrival when the signal arrives at the sensor 12i may be selected, for example, by determining thresholds to a signal-to-noise-ratio (SNR) of the signal. Specifically, the time of arrival of the signal may be a time when the SNR of the signal becomes equal to or greater than a predetermined SNR.

In a period where the TOA evaluation period is from the time (t₀−t_{c}) to the time (t₀+t_{c}), the TOA input means 111 may define a time to at which the SNR of the signal detected by the sensor 12i becomes, for example, 10 dB (decibel) or more as [a time when the signal is detected, that is, a candidate value of the TOA], and store the time to.

In the TOA evaluation period, the TOA input means 111 may define a time when the signal amplitude becomes equal to or larger than a predetermined amplitude as a candidate value of the TOA, and store the candidate value of the TOA.

Further, the TOA input means 111 may define, as a candidate value of the TOA, a time when a difference between samples of the signal amplitude (time difference data of the signal) becomes equal to or larger than a predetermined amplitude difference for the purpose of detecting a temporal shift of the signal derived from the sound, and store the candidate value of the TOA.

Herein, defining and determining candidate values of TOA by using differences between SNR, signal amplitude, and samples of signal amplitude is referred to as threshold determination. In the example embodiment, when M or less TOAs appear due to the threshold determination, it is considered that a signal is generated at the same time, and the time of the immediately preceding threshold determination result is stored as a candidate value of TOA. The stored TOA candidate values are labeled 1, 2, 3, . . . , M in order from the smallest value. The candidate value of the TOA, which is the candidate value of the TOA of the sensor 12i and is labeled a-th from the smaller one, is denoted by tᵢ^{α}. Herein, α=1, 2, 3, . . . , M. Further, the candidate value of the TOA, which is the candidate value of the TOA of the sensor 12j and is labeled B-th from the smaller one, is denoted as tⱼ^{β}. Herein, β=1, 2, 3, . . . , M.

### <TDOA Candidate Value Evaluation Means>

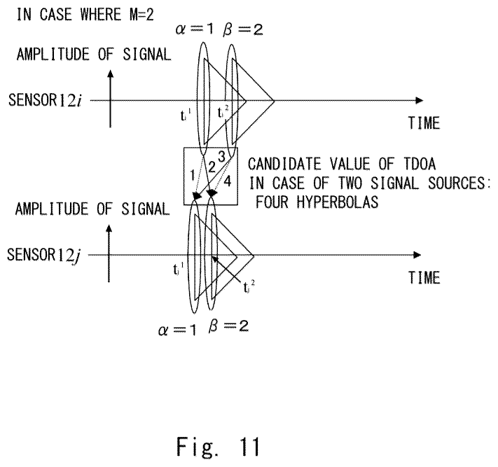

FIG. 11 is a graph illustrating signal waveforms of signal received by the sensors according to the example embodiment.

FIG. 11 illustrates signal waveforms detected by the sensors 12i and 12j when the number M of signal sources is 2. The sensor 12i is one of the plurality of sensors 12, and the sensor 12j is another one of the plurality of sensors 12.

As illustrated in FIG. 11, the TDOA candidate value evaluation means 112 calculates all candidate values of TDOA between two sensors (the sensors 12i and 12j) selected from among the plurality of sensors 12, for all combinations of two sensors. Specifically, the TDOA candidate value evaluation means 112 evaluates (tᵢ^{α}−tᵢ^{β}) being a candidate value of TDOA between the sensor 12i and the sensor 12j from (information about) TOA acquired by the TOA input means 111, and accumulates (stores) the candidate value (tᵢ^{α}−tᵢ^{β}).

There are up to M×M=M² patterns of TDOA candidate values between the two sensors. Therefore, when there are two signal sources (when M=2), the following four patterns are acquired. Herein, α=1 and β=2.
(tᵢ¹−tⱼ¹)
(tᵢ¹−tⱼ²)
(tᵢ²−tⱼ¹)
(tᵢ²−tⱼ²)

Note that, as described above, the TDOA candidate value (tᵢ^{α}−tⱼ^{β}) may be limited according to a predetermined condition. For example, the TOA may be limited to a time when the SNR of the signal becomes equal to or greater than a predetermined SNR. As a result, the TOA caused by noise other than the signal source can be excluded from the evaluation target, and thereby the accuracy of the position estimation of the signal source can be further improved.

In addition, when calculating the candidate value of the TDOA, the TDOA candidate value evaluation means 112 may use only the TOA in the TOA evaluation period and not use the TOA outside the TOA evaluation period. As a result, since a signal outside the TOA evaluation period is excluded from the evaluation target, the position of the signal source can be estimated with higher accuracy.

### <Solution Candidate Distribution Derivation Means>

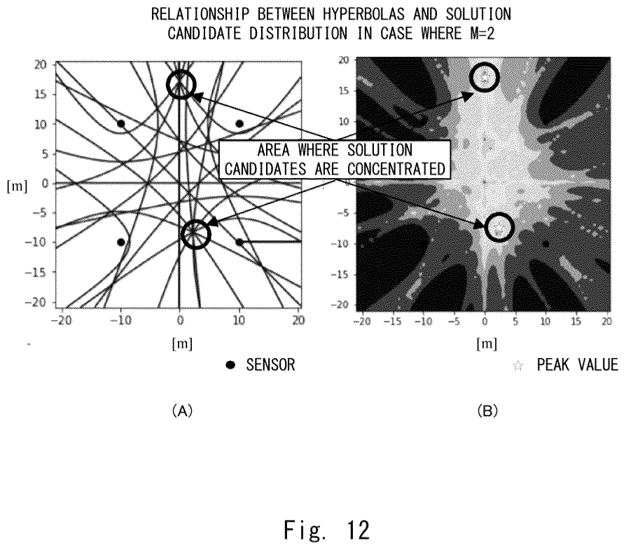

FIG. 12 is a graph illustrating hyperbolic information according to the example embodiment and a distribution diagram illustrating a solution candidate distribution of a signal source.

FIG. 12(A) illustrates hyperbolic information wherein the number M of signal sources is 2. FIG. 12(B) illustrates a solution candidate distribution wherein the number M of signal sources is 2.

FIG. 12 illustrates a relationship between the hyperbola and the solution candidate distribution wherein the number M of signal sources is 2.

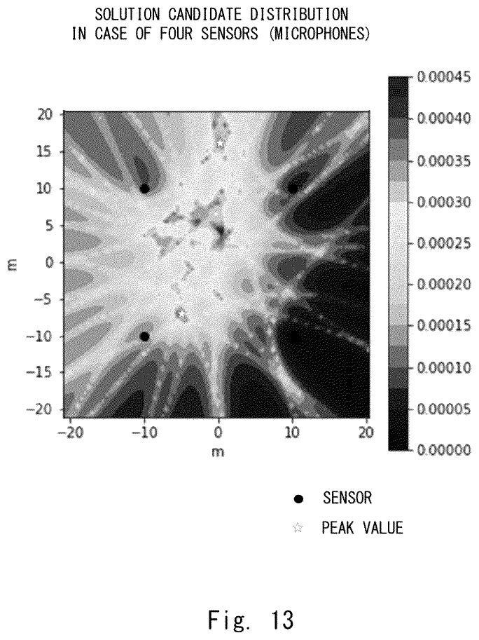

FIG. 13 is a distribution diagram illustrating a solution candidate distribution of a signal source according to the example embodiment.

FIG. 13 illustrates a case where the number N of the sensors 12 is 2.

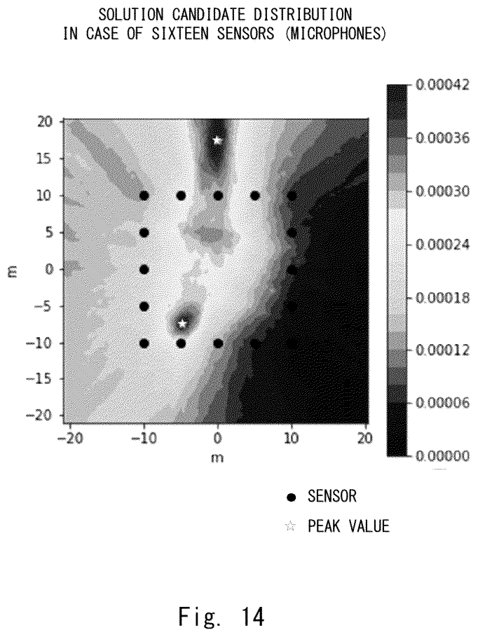

FIG. 14 is a distribution diagram illustrating a solution candidate distribution of a signal source according to the example embodiment.

FIG. 14 illustrates a case where the number N of sensors 12 is 16.

In FIGS. 13 and 14, a microphone for detecting a sound source is used as a sensor.

The solution candidate distribution derivation means 113 calculates a plurality of pieces of hyperbolic information as illustrated in FIG. 12(A), based on the coordinates of each of the plurality of sensors 12 and the candidate values of the TDOA.

Specifically, the solution candidate distribution derivation means 113 draws a hyperbola represented by equation (4) from between the sensors 12i and 12j, based on all patterns of the candidate values of TDOA calculated by the TDOA candidate value evaluation means 112 (see FIG. 12(A)). Herein, all patterns of the candidate values of TDOA means all patterns including incorrect TDOA patterns.

$$\sqrt{{( {{x}_{i}}^{α} - x )}^{2} + {( {{y}_{i}}^{α} - y )}^{2}} - \sqrt{( {{x}_{j}}^{β} - {x}^{2} ) + {( {{y}_{j}}^{β} - y )}^{2}} - c ( {{t}_{i}}^{α} - {{t}_{j}}^{β} ) ≡ {{f}_{ij}}^{αβ} ( x , y ) = 0 \qquad ( 4 )$$

Herein, α and β are labeled numbers derived from the number M of signal sources. In a case where the number of sensors 12 is N, M²×_{N}C₂ types of hyperbolas are drawn, and at most
2_{M}_{²}_{_{N}}_{C}_{₂}C₂
   intersections are included therein.

The solution candidate distribution derivation means 113 further derives a solution candidate distribution formed by distributing whether a predetermined coordinate is a coordinate of a plurality of signal sources, based on the plurality of pieces of hyperbolic information.

Specifically, the solution candidate distribution derivation means 113 derives and displays the distribution of the solution candidate points by using equation (5) (see FIG. 12(B)).

That is, for each of the plurality of pieces of hyperbolic information, the solution candidate distribution derivation means 113 calculates an inverse number of an absolute value of a two-dimensional function including hyperbolic information and having a predetermined coordinate (x, y) as a variable, and multiplies the inverse number by all the sensors and all the plurality of signal sources to derive a solution candidate distribution. Note that, the solution candidate distribution derivation means 113 may derive a solution candidate distribution by performing addition instead of multiplication.

$$Z ( x , y ) ≡ A {\prod }_{i = 1}^{N} {\prod }_{j = i}^{N} {\prod }_{α = 1}^{M} {\prod }_{β = i}^{M} \frac{1}{\vert {{f}_{ij}}^{αβ} ( x , y ) \vert + {0}_{+}} \qquad ( 5 )$$

In the solution candidate distribution, the distribution value becomes larger as the predetermined coordinates (x, y) become closer to any one of the plurality of signal sources, and the distribution value becomes smaller as the predetermined coordinates (x, y) become farther from any one of the plurality of signal sources. Therefore, when the distribution of the solution candidate points is displayed as in equation (5), an [area where solution candidates are concentrated] appears as the peak value of the distribution (see FIG. 12(B)).

Further, as illustrated in FIGS. 13 and 14, the peak of the solution candidate distribution in a case where the number N of the sensors 12 is 16 (see FIG. 14) is more clearly expressed than the peak of the solution candidate distribution in a case where the number N of the sensors 12 is 4 (see FIG. 13). As the number N of sensors 12 increases, the influence of other solution candidates being noise factors decreases, and the peak (indicated by a star) of the distribution appears clearly near the original solution. Therefore, it is desirable that the number of sensors 12 is larger.

Note that, in the present example, the solution candidate distribution is expressed by the function Z(x, y), but the present invention is not limited thereto. That is, the function is not limited to Z(x, y) as long as the distributivity of the solution can be expressed. For example, hyperbolas and intersections thereof may be calculated by using all patterns of the candidate values of the TDOA, and then the solution candidate distribution may be expressed by a product of two-dimensional normal distributions acquired by averaging each solution candidate coordinates.

### <Distribution Peak Extraction Means>

The distribution peak extraction means 114 extracts M peak values from the higher peak value, and sets the extracted M coordinates as the position estimation result of the signal sources.

Specifically, the distribution peak extraction means 114 extracts a plurality of peak coordinates having a distribution value higher than the surrounding distribution values from a solution candidate distribution as illustrated in FIG. 12(B), FIG. 13, or FIG. 14. The distribution peak extraction means 114 estimates the extracted plurality of peak coordinates as the generation positions of the plurality of signal sources.

Note that a limit may be applied when extracting the peak coordinates. For example, the distribution peak extraction means 114 may extract a plurality of specific peak coordinates having a distribution value equal to or larger than a predetermined distribution value from among the plurality of peak coordinates, and estimate the plurality of specific peak coordinates as the generation positions of the plurality of signal sources.

### Effect

According to the example embodiment, all of the candidate values of TDOA between two sensors are calculated for all combinations of the two sensors, hyperbolic information is calculated based on the coordinates of the sensors and the candidate values of TDOA, a solution candidate distribution is derived based on the hyperbolic information, and the peak coordinates of the solution candidate distribution are estimated as the generation positions of the signal sources.

As a result, it is possible to provide a signal source position estimation apparatus, a system, and a method capable of accurately estimating positions of each of a plurality of different signal sources even when signals are generated from the plurality of signal sources at substantially the same time, and a non-transitory computer-readable medium. Note that the plurality of signals may be signals similar to each other or signals not similar to each other.

In addition, according to the example embodiment, there is no need for signal separation processing. Accordingly, the processing time for estimating the generation position of the signal source may be shortened.

Further, in the example embodiment, as the number of sensors increases, the accuracy of acquiring solution candidates improves (see FIGS. 13 and 14). Therefore, it is desirable that the number of sensors is larger.

Further, in the example embodiment, in position detection of a suddenly generated signal, even when a sudden noise of another origin is included in a TOA evaluation period, all the candidate values of the TDOA are calculated for all combinations of two sensors, and therefore the sudden noise may be removed from the solution candidates. The TOA evaluation period may be also referred to as an evaluation frame.

Although the present invention has been described as a hardware configuration in the above-described example embodiment, the present invention is not limited thereto. The present invention may also achieve the processing of each configuration element by causing a central processing unit (CPU) to execute a computer program.

In the above-described example embodiment, the program may be stored and provided to the computer by using various types of non-transitory computer-readable media. Non-transitory computer-readable media include various types of tangible storage media. Examples of the non-transitory computer-readable media include a magnetic recording medium (specifically, a flexible disk, a magnetic tape, or a hard disk drive), a magneto-optical recording medium (specifically, a magneto-optical disk), a CD-read only memory (ROM), a CD-R, a CD-R/W, a semiconductor memory (specifically, a mask ROM, a programmable ROM (PROM), or an erasable PROM (EPROM)), a flash ROM, and a random access memory (RAM). The program may also be provided to the computer by various types of transitory computer-readable media. Examples of transitory computer-readable media include electrical signals, optical signals, and electromagnetic waves. The transitory computer-readable medium may supply the program to the computer via a wired communication path such as an electric wire or an optical fiber, or via a wireless communication path.

Although the present invention has been described with reference to the example embodiment, the present invention is not limited to the above. Various modifications that can be understood by a person skilled in the art within the scope of the invention may be made to the configuration and details of the present invention.

The present invention is not limited to the above-described example embodiment, and may be modified as appropriate without departing from the spirit and scope thereof.

Some or all of the above-described example embodiments may be described as the following supplementary notes, but are not limited thereto.

### Supplementary Note 1

A signal source position estimation apparatus including:
a time difference of arrival (TDOA) candidate value evaluation means for calculating, for all combinations of two sensors selected from among a plurality of sensors, all candidate values of a time difference of arrival being a difference in time of arrival (TOAs) of signals generated from each of a plurality of signal sources between the two sensors;
a solution candidate distribution derivation means for calculating a plurality of pieces of hyperbolic information, based on coordinates of each of the plurality of sensors and the candidate values of time difference of arrival, and deriving a solution candidate distribution formed by distributing whether predetermined coordinates are coordinates of the plurality of signal sources, based on the plurality of pieces of hyperbolic information; and
a distribution peak extraction means for extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

### Supplementary Note 2

The signal source position estimation apparatus according to supplementary note 1, wherein, in a case where the coordinates of the plurality of signal sources on a two-dimensional plane are estimated by using the plurality of sensors arranged in the two-dimensional plane, the plurality of sensors are four or more independent sensors.

### Supplementary Note 3

The signal source position estimation apparatus according to supplementary note 1 or 2, wherein the TDOA candidate value evaluation means uses only the time of arrival within a TOA evaluation period when calculating the candidate values of the time difference of arrival.

### Supplementary Note 4

The signal source position estimation apparatus according to supplementary note 1 or 2, wherein, when calculating the plurality of pieces of hyperbolic information, the solution candidate distribution derivation means does not use, among the candidate values of the time difference of arrival calculated for all combinations of the sensors, a candidate value of the time difference of arrival being equal to or more than a predetermined time.

### Supplementary Note 5

The signal source position estimation apparatus according to any one of supplementary notes 1 to 4, wherein the solution candidate distribution derivation means:
calculates, for each of the plurality of pieces of hyperbolic information, an inverse number of an absolute value of a two-dimensional function including the hyperbolic information and using the predetermined coordinates as a variable; and
derives the solution candidate distribution by multiplying or adding the inverse number by all of the sensors and all of the plurality of signal sources.

### Supplementary Note 6

The signal source position estimation apparatus according to any one of supplementary notes 1 to 5, wherein the distribution peak extraction means extracts a plurality of specific peak coordinates having a distribution value equal to or larger than a predetermined distribution value from among the plurality of peak coordinates, and estimates the plurality of specific peak coordinates as the generation positions of the plurality of signal sources.

### Supplementary Note 7

The signal source position estimation apparatus according to any one of supplementary notes 1 to 6, wherein, in the solution candidate distribution, a distribution value becomes larger as the predetermined coordinates become closer to any one of the plurality of signal sources, and a distribution value becomes smaller as the predetermined coordinates become farther from any one of the plurality of signal sources.

### Supplementary Note 8

The signal source position estimation apparatus according to any one of supplementary notes 1 to 7, wherein the time of arrival is a time when a signal-to-noise ratio (SNR) of the signal becomes equal to or more than a predetermined SNR.

### Supplementary Note 9

A system including a plurality of sensors and a signal source position estimation apparatus, wherein
each of the plurality of sensors includes
   a detection means for detecting a signal generated from each of a plurality of signal sources, and
   a notification means for notifying the signal source position estimation apparatus of a plurality of times of arrival (TOAs) indicating times when the generated signals arrive at the plurality of sensors,
the signal source position estimation apparatus includes
   a time difference of arrival (TDOA) candidate value evaluation means for calculating, for all combinations of two sensors selected from among the plurality of sensors, all candidate values of a time difference of arrival being a difference in time of arrival of signals generated from each of the plurality of signal sources between the two sensors,
   a solution candidate distribution derivation means for calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information, and
   a distribution peak extraction means for extracting a plurality of peak coordinates having a distribution value higher than surrounding distribution values from the solution candidate distribution, and estimating the plurality of peak coordinates as generation positions of the plurality of signal sources, and
the time of arrival is a time when a signal generated from each of the plurality of signal sources arrives at each of the plurality of sensors.

### Supplementary Note 10

The system according to supplementary note 9, wherein in a case where coordinates of the plurality of signal sources on a two-dimensional plane are estimated by using the plurality of sensors arranged in the two-dimensional plane, the plurality of sensors are four or more independent sensors.

### Supplementary Note 11

A method including:
calculating, for all combinations of two sensors selected from among a plurality of sensors, all candidate values of a time difference of arrival (TDOA) being a difference in times of arrival (TOAs) of signals generated from each of a plurality of signal sources between the two sensors;
calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

### Supplementary Note 12

A non-transitory computer-readable medium storing a program that causes a computer to execute:
calculating, for all combinations of two sensors selected from among a plurality of sensors, all candidate values of a time difference of arrival (TDOA) being a difference in time of arrival (TOAs) of signals generated from each of a plurality of signal sources between the two sensors;
calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

### REFERENCE SIGNS LIST

10 SYSTEM
11 SIGNAL SOURCE POSITION ESTIMATION APPARATUS
111 TOA INPUT MEANS
112 TDOA CANDIDATE VALUE EVALUATION MEANS
113 SOLUTION CANDIDATE DISTRIBUTION DERIVATION MEANS
114 DISTRIBUTION PEAK EXTRACTION MEANS
12, 12i, 12j SENSOR
121 DETECTION MEANS
122 NOTIFICATION MEANS
TOA TIME OF ARRIVAL
TDOA TIME DIFFERENCE OF ARRIVAL
A, B SIGNAL SOURCE
(x, y) PREDETERMINED COORDINATES

What is claimed is:

1. A signal source position estimation apparatus comprising:
at least one memory storing instructions, and
at least one processor configured to execute the instructions to;
calculate, for all combinations of two sensors selected from among a plurality of sensors, all candidate values of a time difference of arrival being a difference in time of arrival (TOAs) of signals generated from each of a plurality of signal sources between the two sensors;
calculate a plurality of pieces of hyperbolic information, based on coordinates of each of the plurality of sensors and the candidate values of the time difference of arrival, and derive a solution candidate distribution formed by distributing whether predetermined coordinates are coordinates of the plurality of signal sources, based on the plurality of pieces of hyperbolic information; and
extract a plurality of peak coordinates having a distribution value higher than surrounding distribution values from the solution candidate distribution, and estimate the plurality of peak coordinates as generation positions of the plurality of signal sources,
wherein the time of arrival is a time when a signal generated from each of the plurality of signal sources arrives at each of the plurality of sensors.

2. The signal source position estimation apparatus according to claim 1, wherein, in a case where the coordinates of the plurality of signal sources on a two-dimensional plane are estimated by using the plurality of sensors arranged in the two-dimensional plane, the plurality of sensors are four or more independent sensors.

3. The signal source position estimation apparatus according to claim 1, wherein the at least one processor configured to execute the instructions to use only the time of arrival within a TOA evaluation period when calculating the candidate values of the time difference of arrival.

4. The signal source position estimation apparatus according to claim 1, wherein, when calculating the plurality of pieces of hyperbolic information, the at least one processor configured to execute the instructions not to use, among the candidate values of the time difference of arrival calculated for all combinations of the sensors, a candidate value of the time difference of arrival being equal to or more than a predetermined time.

5. The signal source position estimation apparatus according to claim 1, wherein the at least one processor configured to execute the instructions to:
calculate, for each of the plurality of pieces of hyperbolic information, an inverse number of an absolute value of a two-dimensional function including the hyperbolic information and using the predetermined coordinates as a variable; and
derive the solution candidate distribution by multiplying or adding the inverse number by all of the sensors and all of the plurality of signal sources.

6. The signal source position estimation apparatus according to claim 1, wherein the at least one processor configured to execute the instructions to extract a plurality of specific peak coordinates having a distribution value equal to or larger than a predetermined distribution value from among the plurality of peak coordinates, and estimate the plurality of specific peak coordinates as the generation positions of the plurality of signal sources.

7. The signal source position estimation apparatus according to claim 1, wherein, in the solution candidate distribution, a distribution value becomes larger as the predetermined coordinates become closer to any one of the plurality of signal sources, and a distribution value becomes smaller as the predetermined coordinates become farther from any one of the plurality of signal sources.

8. The signal source position estimation apparatus according to claim 1, wherein the time of arrival is a time when a signal-to-noise ratio (SNR) of the signal becomes equal to or more than a predetermined SNR.

9. A system comprising a plurality of sensors and a signal source position estimation apparatus, wherein
each of the plurality of sensors includes
at least one sensor-memory storing instructions, and
at least one sensor-processor configured to execute the instructions to;
detect a signal generated from each of a plurality of signal sources, and
notify the signal source position estimation apparatus of a plurality of times of arrival (TOAs) indicating times when the generated signals arrive at the plurality of sensors,
the signal source position estimation apparatus includes
at least one apparatus-memory storing instructions, and
at least one apparatus-processor configured to execute the instructions to;
calculate, for all combinations of two sensors selected from among the plurality of sensors, all candidate values of a time difference of arrival being a difference in time of arrival of signals generated from each of the plurality of signal sources between the two sensors,
calculate a plurality of pieces of hyperbolic information, based on coordinates of each of the plurality of sensors and the candidate values of the time difference of arrival, and derive a solution candidate distribution formed by distributing whether predetermined coordinates are coordinates of the plurality of signal sources, based on the plurality of pieces of hyperbolic information, and
extract a plurality of peak coordinates having a distribution value higher than surrounding distribution values from the solution candidate distribution, and estimate the plurality of peak coordinates as generation positions of the plurality of signal sources, and
the time of arrival is a time when a signal generated from each of the plurality of signal sources arrives at each of the plurality of sensors.

10. The system according to claim 9, wherein, in a case where coordinates of the plurality of signal sources on a two-dimensional plane are estimated by using the plurality of sensors arranged in the two-dimensional plane, the plurality of sensors are four or more independent sensors.

11. A method comprising:
calculating, for all combinations of two sensors selected from among a plurality of sensors, all candidate values of a time difference of arrival (TDOA) being a difference in time of arrival (TOAs) of signals generated from each of a plurality of signal sources between the two sensors;
calculating a plurality of pieces of hyperbolic information, based on coordinates of each of the plurality of sensors and the candidate values of the time difference of arrival, and deriving a solution candidate distribution formed by distributing whether predetermined coordinates are coordinates of the plurality of signal sources, based on the plurality of pieces of hyperbolic information; and
extracting a plurality of peak coordinates having a distribution value higher than surrounding distribution values from the solution candidate distribution, and estimating the plurality of peak coordinates as generation positions of the plurality of signal sources,
wherein the time of arrival is a time when a signal generated from each of the plurality of signal sources arrives at each of the plurality of sensors.

12. (canceled)
